(19) United States
(12) Patent Application Publication
(10) Pub. No.: US 2006/0095811 A1
(43) Pub. Date: May 4, 2006

(54) Apparatus and method for graphics memory controlling hub (GMCH) clocking support for dual television encoders

(76) Inventor: Damon Afualo, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/942,212

(22) Filed: Sep. 15, 2004

(51) Int. Cl. G06F 1/04

(52) U.S. Cl. 713/503

(57) ABSTRACT

An apparatus and method for graphics memory controlling hub (GMCH) clocking support for dual television encoders are described. In an embodiment, the apparatus is a GMCH that includes a digital video output (DVO) interface, a DVO clock input, and a reconfigured video graphics array (VGA) clock input. The DVO interface sends video to a first device and a second device. The first and second devices may be television encoders. The GMCH receives a first clock frequency from the first device via the DVO clock input. The GMCH receives a second clock frequency from the second device via the reconfigured VGA clock input.

### BACKGROUND

Graphics memory controlling hubs (GMCHs) provide digital video display support for television encoders and for digital visual interface/low voltage differential signaling (DVI/LVDS) transmitters. Television encoders generate video display on standard and high-definition television sets. In addition, GMCHs also provide analog video display support for video graphic array (VGA) displays. GMCHs contain a digital video output (DVO) interface that allows the GMCH to send video via DVO ports in the DVO interface.

A television encoder is dependent on being able to feedback a unique clock frequency to the GMCH in order to ensure that video is properly displayed on the television. Although a VGA display does not typically feedback a clock, it is typically the responsibility of a system clocking chip to feed the VGA clock to the GMCH. The system clock chip must be configured by software to provide the proper frequency to the GMCH when its associated pin is used to enable VGA functions of the GMCH (the default configuration). Thus, like a television encoder, a VGA display must be able to have its unique click frequency fed to the GMCH via a system clocking chip in order to ensure that video is properly displayed on the VGA display. A DVI/LVDS transmitter, on the other hand, does not depend on being able to feedback a unique clock frequency to the GMCH in order to ensure that video is properly displayed.

The clock frequency of a television encoder differs from the clock frequency of a VGA display. Thus, GMCHs typically have two clock inputs, one is DVO-dedicated for a television encoder to feedback its unique clock frequency to the GMCH and another is VGA-dedicated for a VGA display to feedback its unique clock frequency via a system clocking chip to the GMCH.

A GMCH often has two DVO ports in its DVO interface to support sending digital video to two devices at the same time. The two devices could be a television encoder and a DVI/LVDS transmitter, two television encoders or two DVI/LVDS transmitters. As described above, although a GMCH generally has two DVO ports, it only has a single dedicated DVO clock input for a television encoder to feedback its unique clock frequency and thus a single digital clock feedback line. Accordingly, if the GMCH is using the two DVO ports to send video to two television encoders at the same time, then only one of the television encoders could directly use the single digital clock feedback line. The other would have to try and function properly off of the clock frequency of the encoder directly using the clock feedback line. This might work if the dual television encoders are exactly the same and their respective televisions are displaying the exact same program. But if more advanced and compelling features are desired, such as (but not limited to) standard definition programming on one television and high definition on the another television or watching different programs on the dual televisions, then video would not always get correctly displayed on the television whose encoder is not directly utilizing the clock feedback line.

### BRIEF DESCRIPTION OF THE DRAWINGS

The invention may be best understood by referring to the following description and accompanying drawings that are used to illustrate embodiments of the invention. In the drawings:

FIG. 1 illustrates one embodiment of a graphics memory controlling hub (GMCH) in which some embodiments of the present invention may operate;

FIG. 2 is a flow diagram of one embodiment of a process for graphics memory controlling hub (GMCH) clocking support for dual television encoders; and

FIG. 3 is a flow diagram for one embodiment of a process for reconfiguring a dedicated VGA clock input to accept the clock frequency of a television encoder.

### DESCRIPTION OF EMBODIMENTS

An apparatus and method for graphics memory controlling hub (GMCH) clocking support for dual television encoders are described. In an embodiment of the invention, a GMCH provides unique feedback lines for dual television encoders by reconfiguring a dedicated VGA clock input to accept the clock frequency of a television encoder. In the following description, for purposes of explanation, numerous specific details are set forth. It will be apparent, however, to one skilled in the art that embodiments of the invention can be practiced without these specific details.

Embodiments of the present invention may be implemented in software, firmware, hardware or by any combination of various techniques. For example, in some embodiments, the present invention may be provided as a computer program product or software which may include a machine or computer-readable medium having stored thereon instructions which may be used to program a computer (or other electronic devices) to perform a process according to the present invention. In other embodiments, steps of the present invention might be performed by specific hardware components that contain hardwired logic for performing the steps, or by any combination of programmed computer components and custom hardware components.

Thus, a machine-readable medium may include any mechanism for storing or transmitting information in a form readable by a machine (e.g., a computer). These mechanisms include, but are not limited to, a hard disk, floppy diskettes, optical disks, Compact Disc, Read-Only Memory (CD-ROMs), magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, a transmission over the Internet, electrical, optical, acoustical or other forms of propagated signals (e.g., carrier waves, infrared signals, digital signals, etc.) or the like.

Some portions of the detailed descriptions that follow are presented in terms of algorithms and symbolic representations of operations on data bits within a computer system's registers or memory. These algorithmic descriptions and representations are the means used by those skilled in the data processing arts to convey the substance of their work to others skilled in the art most effectively. An algorithm is here, and generally, conceived to be a self-consistent sequence of operations leading to a desired result. The operations are those requiring physical manipulations of physical quantities. Usually, although not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that discussions utilizing terms such as “processing” or “computing” or “calculating” or “determining” or the like, may refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Reference throughout this specification to “one embodiment” or “an embodiment” means that a particular feature, structure, or characteristic described in connection with the embodiment is included in at least one embodiment of the invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the following detailed description of the embodiments, reference is made to the accompanying drawings that show, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention.

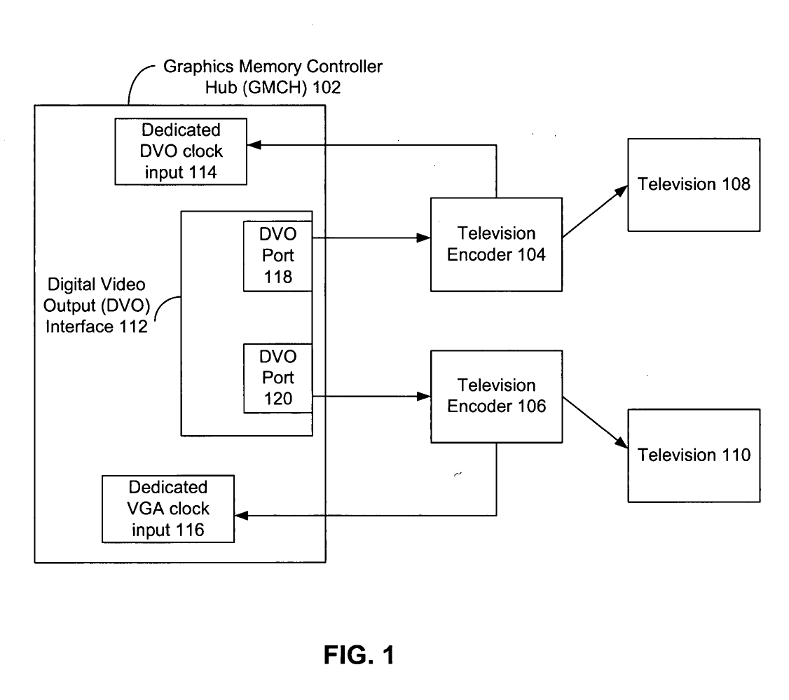

FIG. 1 illustrates one embodiment of a graphics memory controlling hub (GMCH) in which some embodiments of the present invention may operate. The embodiment in FIG. 1 includes, but is not necessarily limited to, a GMCH 102, a television encoder 104, a television encoder 106, a television 108 and a television 110. GMCH 102 may further include, but is not limited to, a digital video output (DVO) interface 112, a dedicated DVO clock input 114 and a dedicated VGA clock input 116. DVO interface 112 may further include, but is not limited to, a DVO port 118 and a DVO port 120. Each of these components is described further next.

GMCH 102 provides digital video display support for television encoder 104 and its respective television 108 and for television encoder 106 and its respective television 110. GMCH 102 also may provide digital video display support for one or more digital visual interface/low voltage differential signaling (DVI/LVDS) transmitters (not shown in FIG. 1) and analog video display support for one or more video graphic array (VGA) displays (also not shown in FIG. 1). The present invention is not limited to a GMCH, but may be applied to any computer chip that provides video display support.

DVO interface 112 allows GMCH 102 to send video data via DVO ports 118 and 120 to television encoders 104 and 106 and to one or more DVI/LVDS transmitters. Television encoders 104 and 106 are dependent on being able to feedback a unique clock frequency to GMCH 102 in order to ensure that video is properly displayed on televisions 108 and 110, respectively. Although a VGA display does not typically feedback a clock, it is typically the responsibility of a system clocking chip to feed the VGA clock to the GMCH. The system clock chip must be configured by software to provide the proper frequency to the GMCH when its associated pin is used to enable VGA functions of the GMCH (the default configuration). Thus, like a television encoder, a VGA display must be able to have its unique click frequency fed to the GMCH via a system clocking chip in order to ensure that video is properly displayed on the VGA display. A DVI/LVDS transmitter, on the other hand, does not depend on being able to feedback a unique clock frequency to the GMCH in order to ensure that video is properly displayed.

GMCH 102 utilizes dedicated DVO clock input 114 to create a single clock feedback line for one or more devices or components receiving video from DVO interface 112. In an embodiment of the invention, the devices may be one or more television encoders (such as television encoders 104 and 106) and/or one or more DVI/LVDS transmitters. Clock feedback lines are important for devices (e.g., television encoders and VGA displays) who need to feedback a unique clock frequency to GMCH 102 in order to ensure that video is properly displayed. Such a situation is illustrated in FIG. 1 where DVO ports 118 and 120 are each sending different video to television encoders 104 and 106, respectively. If, for example, television encoder 104 is directly using the single digital clock feedback line and encoder 106 is having to try and function properly off of the clock frequency of encoder 104, then the video on the television of encoder 106 will not always be properly displayed.

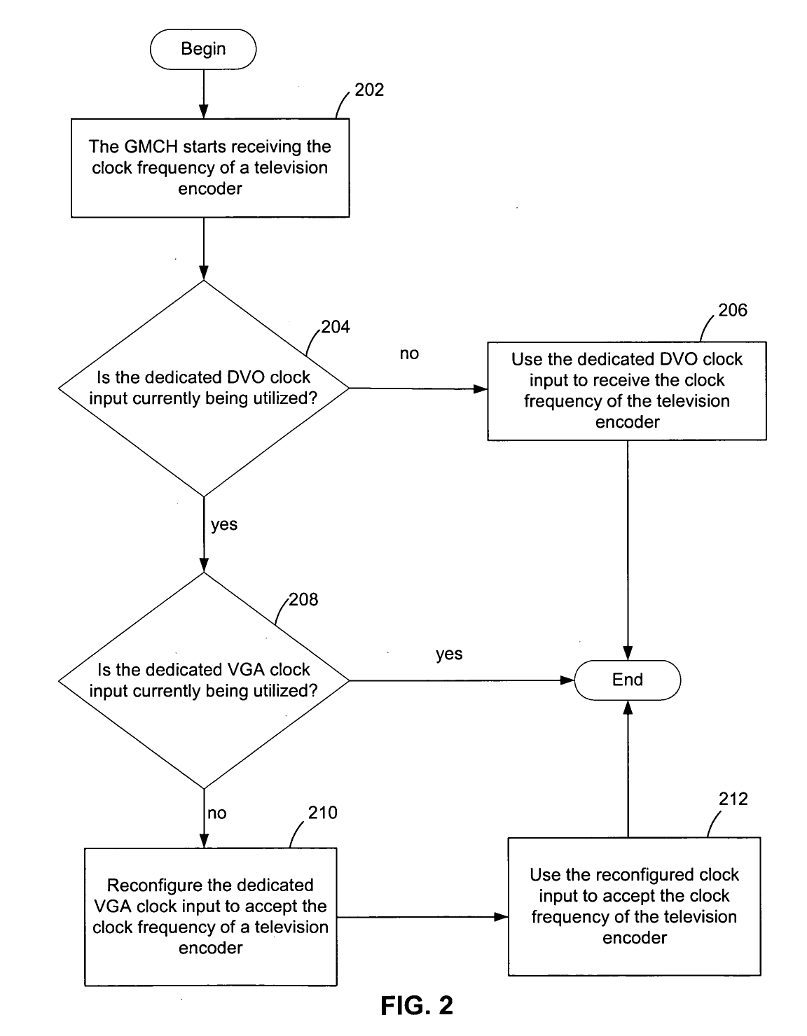

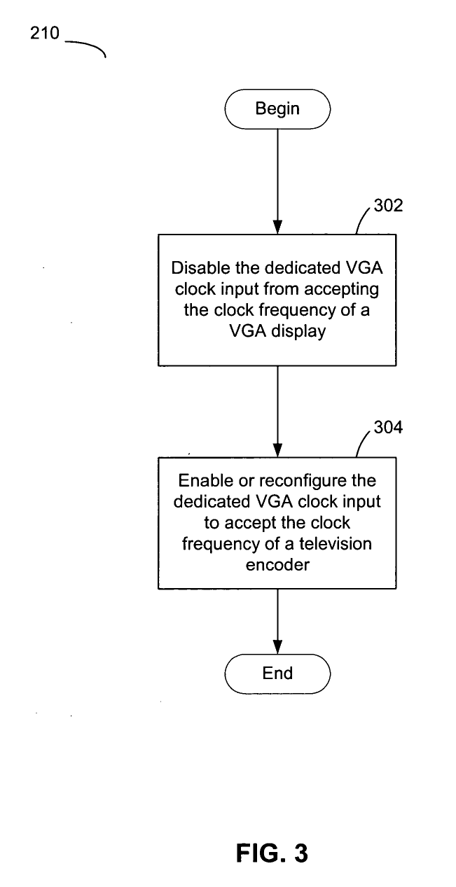

In an embodiment of the invention, GMCH 102 provides unique feedback lines for both television encoders 104 and 106 by reconfiguring dedicated VGA clock input 116 to accept the clock frequency of a television encoder. For example, in the illustration shown in FIG. 1, television encoder 104 utilizes dedicated DVO clock input 114 to provide its clock frequency to GMCH 102 and television encoder 106 utilizes reconfigured dedicated VGA clock input 114 to provide its clock frequency to GMCH 102. Embodiments of the operation of the present invention are described next with reference to FIGS. 2 and 3.

FIG. 2 is a flow diagram of one embodiment of a process for GMCH clocking support for dual television encoders. Assume that GMCH 102 is already sending video via DVO port 118 to television encoder 104. Also assume that television encoder 104 is utilizing dedicated DVO clock input 114 to feedback its clock frequency to GMCH 102.

Referring to FIG. 2, the process begins at processing block 202 where GMCH 102 starts recieving the clock frequency of television encoder 106. At decision block 204, it is determined whether dedicated DVO clock input 114 is currently being used. If not, then control passes to processing block 206 where dedicated DVO clock input 114 is used to receive the clock frequency of television encoder 106. The process in FIG. 2 ends at this point.

Alternatively, if dedicated DVO clock input 114 is currently being used (for example by television encoder 104 as discussed above), then control passes to decision block 208. In decision block 208, it is determined whether dedicated VGA clock input 116 is currently being utilized. If so, then the process in FIG. 2 ends. Here, a VGA display may already be using dedicated VGA clock input 116 to send its clock frequency to GMCH 102. If not, then control passes to processing block 210.

At processing block 210, dedicated VGA clock input 116 is reconfigured to accept the clock frequency of television encoder 106. The difference between the clock of a television encoder and the clock of a VGA display is clock frequency. Processing block 210 is described in more detail below with reference to FIG. 3.

At processing block 212, the reconfigured dedicated VGA clock input 116 is utilized to accept the clock frequency of television encoder 106. The process of FIG. 2 ends at this point.

FIG. 3 is a flow diagram for one embodiment of a process for reconfiguring a dedicated VGA clock input to accept the clock frequency of a television encoder (step 210 of FIG. 2). Referring to FIG. 3, the process begins at processing block 302 where dedicated VGA clock input 116 is disabled from accepting the clock frequency of a VGA display. At processing block 304, dedicated VGA clock input 116 is enabled or reconfigured to accept the clock frequency of television encoder 106. The process in FIG. 3 ends at this point.

The present invention is not limited to GMCH clocking support for dual television encoders. The present invention may be applied to any computer chip that provides video to devices that require the ability to feedback their clock frequency to the computer chip. For example, in an embodiment of the invention, a GMCH provides unique feedback lines for dual VGA displays by reconfiguring a dedicated DVO clock input to accept the clock frequency of a VGA display.

An apparatus and method for GMCH clocking support for dual television encoders have been described. It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. An apparatus, including:
a computer chip, wherein the computer chip includes:
an interface;
a clock input; and
a reconfigured clock input,
wherein the interface sends video to a first device and a second device,
wherein the computer chip receives a first clock frequency from the first device via the clock input,
wherein the computer chip receives a second clock frequency from the second device via the reconfigured clock input, and
wherein the reconfigured clock input has been reconfigured to accept the second clock frequency.

2. The apparatus of claim 1, wherein the computer chip is a graphics memory controller hub (GMCH).

3. The apparatus of claim 1, wherein the interface is a digital video output (DVO) interface.

4. The apparatus of claim 1, wherein the second clock frequency differs from an original clock frequency of the reconfigured clock input.

5. The apparatus of claim 1, wherein the video sent to the first device differs from the video sent to the second device.

6. The apparatus of claim 1, wherein the first and second devices are television encoders.

7. The apparatus of claim 1, wherein the reconfigured clock input has been disabled from accepting the clock frequency of a video graphics array (VGA) display and enabled to accept the clock frequency of the second device.

8. The apparatus of claim 7, wherein the second device is a television encoder.

9. The apparatus of claim 1, wherein the first clock frequency and the second clock frequency are the same.

10. The apparatus of claim 1, wherein the first clock frequency and the second clock frequency are different.

11. An apparatus, including:
a graphics memory controller hub (GMCH), wherein the GMCH includes:
a digital video output (DVO) interface;
a DVO clock input; and
a reconfigured video graphics array (VGA) clock input,
wherein the DVO interface sends video to a first device and a second device,
wherein the GMCH receives a first clock frequency from the first device via the DVO clock input, and
wherein the GMCH receives a second clock frequency from the second device via the reconfigured VGA clock input.

12. The apparatus of claim 11, wherein the video sent to the first device differs from the video sent to the second device.

13. The apparatus of claim 11, wherein the first and second devices are television encoders.

14. The apparatus of claim 11, wherein the reconfigured VGA clock input has been disabled from accepting the clock frequency of a VGA display and enabled to accept the clock frequency of the second device.

15. A method, including:
sending video to a first device and a second device;
receiving a clock frequency from the first device via a clock input; and
reconfiguring another clock input to accept a second clock frequency from the second device.

16. The method of claim 15, further including:
receiving the second clock frequency from the second device via the reconfigured clock input.

17. The method of claim 15, wherein the video is sent to the first device and the second device via a digital video output (DVO) interface in a graphics memory controller hub (GMCH).

18. The method of claim 15, wherein the second clock frequency differs from an original clock frequency of the reconfigured clock input.

19. The method of claim 15, wherein the video sent to the first device differs from the video sent to the second device.

20. The method of claim 15, wherein the first and second devices are television encoders.

21. The method of claim 15, wherein the reconfigured clock input has been disabled from accepting the clock frequency of a video graphics array (VGA) display.

22. The method of claim 15, wherein the first clock frequency and the second clock frequency are the same.

23. The method of claim 15, wherein the first clock frequency and the second clock frequency are different.

24. A method, including:
sending video to a first device and a second device via a digital video output (DVO) interface in a graphics memory controller hub (GMCH);
receiving a clock frequency from the first device via a clock input in the GMCH;
reconfiguring another clock input in the GMCH to accept a second clock frequency from the second device; and
receiving the second clock frequency from the second device via the reconfigured clock input.

25. The method of claim 24, wherein the first and second devices are television encoders.

26. The method of claim 24, wherein the video sent to the first device differs from the video sent to the second device.

27. The method of claim 24, wherein the second clock frequency differs from an original clock frequency of the reconfigured clock input.

28. A machine-readable medium containing instructions which, when executed by a processing system, cause the processing system to perform a method, the method comprising:
sending video to a first device and a second device;
receiving a clock frequency from the first device via a clock input; and
reconfiguring another clock input to accept a second clock frequency from the second device.

29. The machine-readable medium of claim 28, further including:
receiving the second clock frequency from the second device via the reconfigured clock input.

30. The machine-readable medium of claim 28, wherein the second clock frequency differs from an original clock frequency of the reconfigured clock input.

31. The machine-readable medium of claim 28, wherein the video sent to the first device differs from the video sent to the second device.

32. The machine-readable medium of claim 28, wherein the first and second devices are television encoders.

33. The machine-readable medium of claim 28, wherein the reconfigured clock input has been disabled from accepting the clock frequency of a video graphics array (VGA) display.

34. The machine-readable medium of claim 28, wherein the first clock frequency and the second clock frequency are the same.

35. The machine-readable medium of claim 28, wherein the first clock frequency and the second clock frequency are different.
